(19) United States
(12) Patent Application Publication
(10) Pub. No.: US 2018/0105617 A1
(43) Pub. Date: Apr. 19, 2018

(54) HYDROGEL CAPABLE OF BEING USED FOR SEAWATER DESALINATION AND PREPARATION METHOD THEREFOR

(71) Applicant: SOUTH CHINA UNIVERSITY OF TECHNOLOGY, Guangzhou (CN)

(72) Inventors: Shuanshi Fan, Guangzhou (CN); Chi Yu, Guangzhou (CN); Xuemei Lang, Guangzhou (CN); Yanhong Wang, Guangzhou (CN)

(73) Assignee: SOUTH CHINA UNIVERSITY OF TECHNOLOGY, Guangzhou (CN)

(21) Appl. No.: 15/562,585

(22) PCT Filed: Dec. 31, 2015
(86) PCT No.: PCT/CN2015/100039

§ 371 Date: Sep. 28, 2017

(30) Foreign Application Priority Data
Apr. 10, 2015 (CN) 201510168593.7

(51) Int. Cl. C08F 20/04; C08F 2/44; C08J 3/075; C02F 1/28; C08G 63/06

(52) U.S. Cl. CPC C08F 20/04; C08F 2/44; C08J 3/075; C02F 1/285; C02F 2103/08; C08J 2333/08; C08J 2333/12; C08G 2210/00; C08F 2500/24; C08G 63/06

(57) ABSTRACT

A hydrogel capable of desalinating seawater and a preparation method thereof. The hydrogel is a polymer polymerized by a monomer containing a hydrophilic group and a carbon-carbon double bond via carbon-carbon double bonds. A degree of crosslinking of the polymer is 0.01 to 0.2. The monomer accounts for 5 wt % to 50 wt % of a mass of the hydrogel. The preparation method includes: mixing a monomer with a pore-forming agent, a cross-linking agent, a initiator and a catalyst evenly, obtaining a mixed material, then transferring the mixed material into a die; conducting a polymerization for 2 to 3 hours at a temperature of 20° C. to 30° C. first, followed by increasing the temperature to continue the polymerization until the polymerization is completed; and obtaining the hydrogel capable of desalinating seawater. The method according is convenient and efficient, and has advantages of being used under special conditions such as earthquake relief work, maritime rescue and wild adventure.

### TECHNICAL FIELD

The present invention relates to the technical field of seawater desalination and in particular, to a hydrogel capable of desalinating seawater and a preparation method thereof.

### BACKGROUND

Distribution of freshwater resources is uneven and limited at the earth's surface, especially obvious in China. Storage amount of seawater is abundant, but the seawater cannot be for the direct use of people, crops and other creatures. Thus seawater desalination is an effective way to solve the shortage of fresh water. There are more than 20 kinds of current seawater desalination technologies, including positive and negative osmosis, multi-stage flash distillation, electrodialysis, dewvaporation and seawater desalination technologies using nuclear energy and solar energy. However, these methods have the disadvantage of high cost, limiting large-area promotion and application of the seawater desalination technology. At the same time, the current technology often requires large-scale equipment, which has limitations in some sudden, small-scale applications.

Hydrogel is short for a kind of polymer which has characteristics of light crosslinking, water-absorbable but water-insoluble. The hydrogel after being dried has strong water absorbency, and its water absorption and water absorption rate are amazing. Amir Razmjou et al., of Monash University, Australia, used a hydrogel loaded with nano-iron oxide particles as a carrier. In the case of functions of magnetic field and heating together, by using strong water absorbency of the hydrogel, seawater containing a concentration of sodium chloride of 3.5 wt % was provided with a driving force to pass through a semipermeable membrane, thereby achieving a purpose of improving a recovery rate of desalinated seawater. Subsequently, a team of Amir Razmjou et al. reported a method of extracting fresh water from the seawater through a hydrogel with a two-layer structure. By water absorbency of the gel itself and the use of solar irradiation of a gel layer, the team made the seawater pass through the semipermeable membrane into the gel layer, and thus the fresh water was released. However, these methods used the semipermeable membrane for substantial desalination of the seawater, hydrogel in which only played a part in providing the driving force and improving the recovery rate of water. In addition, the above method in operation needs magnetic field for heating or solar irradiation achieving a certain intensity, both of which have a negative impact on convenient application of the technology. In German, a team of Johannes Hopfner et al. of Karlsruhe Institute of Technology (KIT) used sodium polyacrylate for absorption of sodium chloride solution, and a squeezed liquid was obtained by squeezing the hydrogel and its sodium chloride concentration was tested. When the concentration the raw water is 35 g/L NaCl solution, the desalination rate is only 25%.

### SUMMARY OF THE INVENTION

An object of the present invention is to provide a hydrogel capable of desalinating seawater and a preparation method thereof, to overcome the deficiencies of the prior art. The present invention does not require the use of semipermeable membranes to desalinate the seawater, but achieves the purpose of seawater desalination by utilizing structural properties of the hydrogel itself.

Technical principle of the present invention is as follows:

The hydrogel used in the present invention may be a homopolymer or a copolymer synthesized using hydroxyethyl methylacrylate (HEMA) or sodium acrylate (SA) as a monomer. Of course, the monomer that can be used to synthesize the hydrogel capable of desalinating seawater is not limited to this. Monomers of acrylics and methacrylates with carbon-carbon double bond and ester groups also meet the requirements.

In hydrogel's structure, water is a pore-forming agent. The hydrogel of different water content has different shape and size in its internal pore structure. The hydrogel used in the present invention has a pore size between 0.1 μm and 20 μm. This range of the pore size can ensure that the hydrogel has strong water absorption, while ionic hydrates formed by ions in the seawater have a certain filtering effect. In addition, the hydrogel has a good reversibility in water absorption and dehydration, and thus in the control of the appropriate operating conditions, the hydrogel used for seawater desalination can be repeatedly used, and plays a role in energy conservation and environmental protection.

The object of the present invention is realized by following technical solution.

A hydrogel capable of desalinating seawater, the hydrogel is a polymer polymerized by a monomer containing a hydrophilic group and a carbon-carbon double bond via carbon-carbon double bonds. A degree of crosslinking of the polymer is 0.01 to 0.2. The monomer accounts for 5 wt % to 50 wt % of a mass of the hydrogel.

Preferably, the monomer is one or more of compounds of methacrylic acid, acrylic acid, sodium acrylate, methacrylates and acrylates.

Preferably, the methacrylates include one or more of hydroxyethyl methylacrylate (HEMA), (2-hydroxyethoxy)ethyl methacrylate, methoxyethyl methacrylate, (2-methoxyethoxy)ethyl methacrylate, ethylene dimethacrylate (EDMA), and 2-ethoxyethyl methacrylate (EEMA).

Preferably, the acrylates include one or more of methyl acrylate, ethyl acrylate, butyl acrylate, hydroxyethyl acrylate, and methoxyethyl acrylate.

Preferably, the hydrogel is a homopolymer polymerized by a monomer, or a copolymer polymerized by two or more of monomers. A pore size of the hydrogel is 0.1 μm to 20 μm.

A preparation method of the hydrogel capable of desalinating seawater, which is synthesized by a monomer, a pore-forming agent, a cross-linking agent, an initiator and a catalyst, with its specific step being as follows: mixing the monomer with the pore-forming agent, the cross-linking agent, the initiator and the catalyst evenly, obtaining a mixed material, then transferring the mixed material into a die, conducting a polymerization for 2 to 3 hours at a temperature of 20° C. to 30° C. first, follow by increasing the temperature to continue the polymerization until the polymerization is completed; and obtaining the hydrogel capable of desalinating seawater.

In the above-described method, the cross-linking agent is one or more of ethylene dimethacrylate (EDMA), N,N′-methylenebisacrylamide (MBA) and 1,5-hexadiene-3,4-diol (DVG), and a ratio of amount of substance of the cross-linking agent to the monomer is 0.01 to 0.2.

In the above-described method, the initiator is one or more of ammonium persulphate (APS), azodiisobutyronitrile (AIBN) and benzoyl peroxide (BPO), an amount of the initiator being a concentration in the mixed material of 1.0 mmol/L to 3.0 mmol/L. The catalyst is N,N,N′,N′-tetramethylethylenediamine (TEMED), an amount of the catalyst accounting for 0.2% (V/V) to 0.5% (V/V) of a total volume of the mixed material. The pore-forming agent is deionized water, an amount of the pore-forming agent accounting for 50 wt % to 95 wt % of a total weight of the hydrogel.

In the above-described method, when increasing the temperature to continue the polymerization, a polymerization temperature is 40° C. to 120° C., and a polymerization time is 1 hour to 48 hours.

In order to ensure a full contact of all materials and a uniformity of properties of various parts of the hydrogel, the initiator needs to be dispersed into an aqueous solution before an experiment. The pore-forming agent is deionized water. Before adding other raw materials, the pore-forming agent should be thoroughly mixed with the monomer into a homogeneous system. The ratio of the monomer, the pore-forming agent to the cross-linking agent determines the hydrogel's pore structure and performance of seawater desalination. The initiator used for synthesizing the hydrogel according to the present invention needs to be prepared into a 10 wt % aqueous solution of sodium persulphate, an amount of the initiator being that a concentration of ammonium persulphate is 1.75 mM after the initiator is added into the reaction system.

A calibration method of a concentration of sodium chloride is ion chromatography. The concentration of sodium chloride in the obtained solution is quantitatively analyzed by a character that a peak area and of chloride ion in the solution has a linear relationship with its concentration.

A dry gel of the hydrogel is swollen in the seawater first, then the hydrogel with absorbed seawater is mechanically squeezed with a piston squeezing device, and a squeezed liquid is collected. The squeezed liquid is the fresh water obtained after being desalted by the hydrogel. After that a concentration of the squeezed liquid is tested. In practical applications, the hydrogel with absorbed seawater can also be squeezed directly with hand to obtain fresh water.

The hydrogel, a product of the present invention, has a molecular space network structure that of has a certain filtering effect on the ionic hydrate in salt water. Therefore when the seawater passes through the hydrogel, a portion of the ion hydrate is blocked by the pores of the hydrogel, while water molecules are free to pass through, so as to achieve the purpose of separation. The hydrogel can handle a seawater or salt solution with total dissolved solids (TDS) greater than or equal to 35.00 g/L. A whole process of absorbing seawater is driven by an attractive force of the hydrogel to seawater, and the hydrogel can be recycled, thus reducing energy consumption and costs, meeting the requirements of energy saving and environmental protection.

Compared with the prior art, the present invention has advantages and beneficial effects as follows:

The present invention discloses a hydrogel capable of desalinating seawater, using a feature that a hole of the hydrogel has a certain role in filtration and repelling to the ions in seawater, to realize replacing the semipermeable membrane with the hydrogel for seawater desalination. The hydrogel has strong water adsorption, which provides a driving force for seawater to be absorbed into the hydrogel. Compared with a conventional reverse osmosis process requiring a high pressure of 3 MPa to 5 MPa to provide a trans-membrane driving force, the method described in the present invention can save this part of energy consumption.

The degree of cros slinking of the hydrogel polymer obtained in the present invention and a weight parameter of the monomer accounting for a final product during preparation have a determinative effect on the product used for seawater desalination.

The hydrogel used in the present invention reaches hygienic standards of direct contact with the human body, while the desalination process is convenient. Thus the operating method according to the present invention can obtain fresh water by squeezing the hydrogel directly with hand, if necessary. Under circumstances of emergency rescue and disaster relief, long-distance sailing and outdoor adventure, fresh water may be obtained from seawater or brackish water conveniently and efficiently, to supplement the human body needs.

### DETAILED DESCRIPTION OF THE PREFERED EMBODIMENT

The present invention will be further specifically described in detail below in combination with embodiments, but implementations of the present invention are not limited thereto. For process parameters that are not specifically noted, may refer to conventional techniques.

Seawater in the present invention is replaced by an aqueous solution of sodium chloride which is a main ingredient in the seawater at a concentration of 35.00 g/L, but is not limited thereto. The selected hydrogel is poly(hydroxyethyl methacrylate), poly(hydroxyethyl methylacrylate-sodium acrylate), sodium polyacrylate and poly(hydroxyethyl methylacrylate-methacrylic acid). Mass fraction of hydroxyethyl methylacrylate in the poly(hydroxyethyl methylacrylate) is 10 wt %, 15 wt %, 20 wt %, respectively; Mass fraction of hydroxyethyl methylacrylate in the poly(hydroxyethyl methylacrylate-sodium acrylate) is 15 wt % and 10 wt %, respectively, and mass fraction of the sodium acrylate is 5 wt % and 10 wt %, respectively. That is, after polymerization, the monomer accounts for 20 wt % of a total mass of the hydrogel. The hydrogel described in the present invention is not limited thereto.

### Embodiment 1

Poly(hydroxyethyl methylacrylate-sodium acrylate) containing 15 wt % of hydroxyethyl methylacrylate (HEMA) and 5 wt % of sodium acrylate (SA) (HEMA15/SA5) was prepared. 7.5 g of HEMA, 2.5 g of SA and 40 g of water were weighted and put into a conical flask for evenly stirring, and then 150 μl of ethylene dimethacrylate (EDMA), 200 μl of 10% of ammonium persulphate (APS) solution and 100 μl of N,N,N′,N′-tetramethylethylenediamine (TEMED) were added in order and evenly mixed. The evenly mixed solution was transferred to a mold, and the mold was put into a thermostat. Isothermal polymerization was carried out at 30° C. for 3 hours and then at 75° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then squeezed. By testing, the concentration of sodium chloride in the squeezed liquid was 12.40 g/L, and the desalination rate was 64.57%.

### Embodiment 2

Poly(hydroxyethyl methylacrylate-sodium acrylate) containing 10 wt % of hydroxyethyl methylacrylate and 10 wt % of sodium acrylate (HEMA10/SA10) was prepared. 5 g of HEMA, 5 g of SA and 40 g of water were weighted and put into a conical flask for evenly stifling, and then 175 μl of EDMA, 200 μl of 10% APS solution and 100 μl of TEMED were added in order and evenly mixed. The evenly mixed solution was transferred to a mold, and the mold was put into a thermostat. Isothermal polymerization was carried out at 30° C. for 3 hours and then at 75° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then was squeezed. By testing, the concentration of sodium chloride in the squeezed liquid was 15.28 g/L, and the desalination rate was 56.34%.

### Embodiment 3

Poly(hydroxyethyl methylacrylate) containing 20 wt % of hydroxyethyl methylacrylate (HEMA20) was prepared. 10 g of HEMA and 40 g of water were weighted and put into a conical flask for evenly stirring, and then 50 μl of EDMA, 400 μl of 10% APS solution and 100 μl of TEMED were added in order and evenly mixed. The evenly mixed solution was transferred to a mold, and the mold was put into a thermostat. Isothermal polymerization was carried out at 25° C. for 3 hours and then at 80° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then was squeezed. By testing, the concentration of sodium chloride in the squeezed liquid was 25.33 g/L, and the desalination rate was 27.63%.

### Embodiment 4

Poly(hydroxyethyl methylacrylate) containing 15 wt % of hydroxyethyl methylacrylate (HEMA15) was prepared. 7.5 g of HEMA and 42.5 g of water were weighted and put into a conical flask for evenly stirring, and then 37.5 μl of EDMA, 300 μl of 10% APS solution and 75 μl of TEMED were added in order and evenly mixed. The evenly mixed solution was transferred to a mold, and the mold was put into a thermostat. Isothermal polymerization was carried out at 25° C. for 3 hours and then at 80° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then was squeezed. By testing, the concentration of sodium chloride in the squeezed liquid was 26.50 g/L, and the desalination rate was 32.08%.

### Embodiment 5

Poly(hydroxyethyl methylacrylate) containing 10 wt % of hydroxyethyl methylacrylate (HEMA10) was prepared. 5 g of HEMA and 45 g of water were weighted and put into a conical flask for evenly stirring, and then 25 μl of EDMA, 200 μl of 10% APS solution and 50 μl of TEMED were added in order and evenly mixed. The evenly mixed solution was transferred to a mold, and the mold was put into a thermostat. Polymerization was carried out at 25° C. for 3 hours and then at 80° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then was squeezed. By testing, the concentration of sodium chloride in the squeezed liquid was 27.50 g/L, and the desalination rate was 21.42%.

### Embodiment 6

Sodium polyacrylate containing 10 wt % of sodium acrylate (SA10) was prepared. 5 g of SA and 45 g of water were weighted and put into a conical flask for evenly stirring, and then 25 μl of N-N′methylene bisacrylamide (MBA), 200 μl of 10% APS solution and 50 μl of TEMED were added in order and evenly mixed. The evenly mixed solution was transferred to a mold, and the mold was put into a thermostat. Isothermal polymerization was carried out at 25° C. for 3 hours and then at 70° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then was squeezed. By testing, the concentration of sodium chloride in the squeezed liquid was 28.13 g/L, and the desalination rate was 19.51%.

### Embodiment 7

Poly(hydroxyethyl methylacrylate-methacrylic acid) containing and copolymerized by 19.9 wt % of hydroxyethyl methylacrylate and 0.2 wt % of methacrylic acid (MA) was prepared. 10 g of HEMA, 0.1 g of MA and 40 g of water were weighted and put into a conical flask for evenly stirring, and then 50 μl of EDMA, 400 μl of 10% APS solution and 100 μl of TEMED were added in order and evenly mixed. The evenly mixed solution was transferred to a mold, and the mold was put into a thermostat. Isothermal polymerization was carried out at 25° C. for 3 hours and then at 80° C. for 24 hours. The polymerized hydrogel was then washed thoroughly with deionized water and then freeze-dried at −45° C. in a freeze dryer for 24 hours. The hydrogel according to the present invention was obtained. The hydrogel was put into the seawater for swelling and then was squeezed. By testing, the concentration of sodium chloride in the squeezed liquid was 27.69 g/L, and the desalination rate was 20.89%.

The formula of preparing the hydrogel will have a significant effect on the structure of the hydrogel. When the mass fraction of the monomer of the hydrogel is less than 5 wt %, the hydrogel is formed relatively soft and cannot be squeezed, meanwhile the high moisture content leads to the hydrogel exhibiting a large pore structure of 20 μm or more, and the salt ions in seawater cannot be adsorbed and screened; whereas when the mass fraction of the monomer of the hydrogel is more than 50 wt %, a degree of swelling of the whole hydrogel is low, a single treating amount of seawater is small and swelling behavior is not obvious in seawater, a treating time is prolonged while a recovery rate is greatly reduced, and thus there is no practical value. When the degree of crosslinking of the hydrogel is less than 0.01 (molar ratio), the hydrogel exhibits a viscous fluid that does not have dilution properties; whereas when the degree of crosslinking is more than 0.2 (molar ratio), the hydrogel is over cross-linked, resulting in slow swelling in saline while the hydrogel colloid is relatively hard and less favorable for squeezing.

The above-described embodiments of the present invention are just examples for describing the present invention clearly, but not limitation to the implementations of the present invention. For those having ordinary skill in the art, variations or changes in different forms can be made on the basis of the above description. All of the implementations should not and could not be exhaustive herein. Any amendment, equivalent replacement and improvement made within the spirit and principle of the present invention shall all be included within the scope of protection of the claims of the present invention.

1-9. (canceled)

10. A hydrogel capable of desalinating seawater, comprising:
a hydrogel that is a polymer polymerized by a monomer containing a hydrophilic group and a carbon-carbon double bond via carbon-carbon double bonds; a degree of crosslinking of the polymer is 0.01 to 0.2; and the monomer accounts for 5 wt % to 50 wt % of a mass of the hydrogel.

11. The hydrogel capable of desalinating seawater according to claim 10, wherein the monomer is one or more of compounds of methacrylic acid, acrylic acid, sodium acrylate, methacrylates and acrylates.

12. The hydrogel capable of desalinating seawater according to claim 11, wherein the methacrylates include one or more of hydroxyethyl methylacrylate (HEMA), (2-hydroxyethoxy)ethyl methacrylate, methoxyethyl methacrylate, (2-methoxyethoxy)ethyl methacrylate, ethylene dimethacrylate (EDMA), and 2-ethoxyethyl methacrylate (EEMA).

13. The hydrogel capable of desalinating seawater according to claim 11, wherein the acrylates include one or more of methyl acrylate, ethyl acrylate, butyl acrylate, hydroxyethyl acrylate, and methoxyethyl acrylate.

14. The hydrogel capable of desalinating seawater according to claim 10, wherein the hydrogel is a homopolymer polymerized by a monomer, or a copolymer polymerized by two or more of monomers; and a pore size of the hydrogel is 0.1 μm to 20 μm.

15. A method of preparing the hydrogel capable of desalinating seawater according to claim 10, comprising: mixing a monomer with a pore-forming agent, a cross-linking agent, an initiator and a catalyst evenly, obtaining a mixed material, then transferring the mixed material into a die; conducting a polymerization for 2 to 3 hours at a temperature of 20° C. to 30° C. first, followed by increasing the temperature to continue the polymerization until the polymerization is completed; and obtaining the hydrogel capable of desalinating seawater.

16. The method according to claim 15, wherein the cross-linking agent is one or more of ethylene dimethacrylate (EDMA), N,N′-methylenebisacrylamide (MBA) and 1,5-hexadiene-3,4-diol (DVG), and a ratio of amount of substance of the cross-linking agent to the monomer is 0.01 to 0.2.

17. The method according to claim 15, wherein the initiator is one or more of ammonium persulphate (APS), azodiisobutyronitrile (AIBN) and benzoyl peroxide (BPO), an amount of the initiator being a concentration in the mixed material of 1.0 mmol/L to 3.0 mmol/L; the catalyst is N,N,N′,N′-tetramethylethylenediamine (TEMED), an amount of the catalyst accounting for 0.2% (V/V) to 0.5% (V/V) of a total volume of the mixed material; and the pore-forming agent is deionized water, an amount of the pore-forming agent a 50 wt % to 95 wt % of a total weight of the hydrogel.

18. The method according to claim 15, wherein when increasing the temperature to continue the polymerization, a polymerization temperature is 40° C. to 120° C., and a polymerization time is 1 hour to 48 hours.
